(19) United States
(12) Patent Application Publication
(10) Pub. No.: US 2016/0266773 A1
(43) Pub. Date: Sep. 15, 2016

(54) INFORMATION PROCESSING METHOD AND ELECTRONIC DEVICE

(71) Applicant: Lenovo (Beijing) Co., Ltd., Beijing (CN)

(72) Inventor: Fuxing MA, Beijing (CN)

(73) Assignee: LENOVO (BEIJING) CO., LTD., Beijing (CN)

(21) Appl. No.: 14/755,582

(22) Filed: Jun. 30, 2015

(30) Foreign Application Priority Data
Mar. 9, 2015 (CN) 201510103664.5

(51) Int. Cl. G06F 3/0484; G06F 3/0483; G06F 3/0488

(52) U.S. Cl. CPC G06F 3/04845; G06F 3/0488; G06F 3/0483

(57) ABSTRACT

An information processing method and an electronic device are provided. The information processing method is applied to the electronic device, the electronic device includes a touch display unit including a display region and an operation region, and the method includes: detecting a first input operation, the first input operation being an input operation performed in the operation region; identifying the first input operation; and executing a predetermined instruction to move first display content in the display region to a first display region corresponding to the predetermined instruction to generate second display content, if it is determined that the first input operation includes the predetermined instruction, where the first display region is smaller than the display region.

### CROSS REFERENCE TO RELATED APPLICATIONS

The present application claims the priority to Chinese Patent Application No. 201510103664.5, entitled “INFORMATION PROCESSING METHOD AND ELECTRONIC DEVICE”, filed on Mar. 9, 2015 with the State Intellectual Property Office of People's Republic of China, which is incorporated herein by reference in its entirety.

### TECHNICAL FIELD

The disclosure relates to the field of information processing technology, and in particular, to an information processing method and an electronic device.

### BACKGROUND

At present, the mobile terminal tends to have larger and larger screen, while the convenience of one-hand operation when a user holds the mobile terminal with one hand may be impacted seriously due to an oversized screen. In a case that the screen of the mobile terminal is in a size of more than 5 inches, the blind area for one-hand operation may account for 50% or more of the screen of the mobile terminal, thereby impacting significantly the operation experience of the user.

### SUMMARY

An information processing method and an electronic device are provided according to embodiments of the disclosure, to improve operation experience of a user.

In one aspect of the disclosure, an information processing method is provided.

The information processing method includes:

detecting a first input operation, where the first input operation is an input operation performed in an operation region of a touch display unit of an electronic device;

identifying the first input operation; and

executing a predetermined instruction to move first display content in a display region of the touch display unit to a first display region corresponding to the predetermined instruction to generate second display content, if it is determined that the first input operation comprises the predetermined instruction, where the first display region is smaller than the display region.

In another aspect of the disclosure, an electronic device is provided. The electronic device includes a touch display unit including a display region and an operation region, and the electronic device further includes: an operation detection unit, an identification unit and an execution unit.

The operation detection unit is for detecting a first input operation, the first input operation being an input operation performed in the operation region.

The identification unit is for identifying the first input operation detected by the operation detection unit.

The execution unit is for executing a predetermined instruction to move first display content in the display region to a first display region corresponding to the predetermined instruction to generate second display content, in a case that the identification unit determines that the first input operation comprises the predetermined instruction, where the first display region is smaller than the display region.

### BRIEF DESCRIPTION OF THE DRAWINGS

FIG. 1 is a schematic flowchart of an information processing method according to a first embodiment of the disclosure;

FIG. 2a to FIG. 2c are schematic diagrams of displaying display content in a case that an electronic device is held by a right hand according to an embodiment of the disclosure;

FIG. 3 is a schematic flowchart of an information processing method according to a second embodiment of the disclosure;

FIG. 4 is a schematic flowchart of an information processing method according to a third embodiment of the disclosure; and

FIG. 5 is a schematic structural diagram of an electronic device according to an embodiment of the disclosure.

### DETAILED DESCRIPTION OF EMBODIMENTS

In the following, the disclosure is described in details in conjunction with drawings and embodiments.

### A First Embodiment

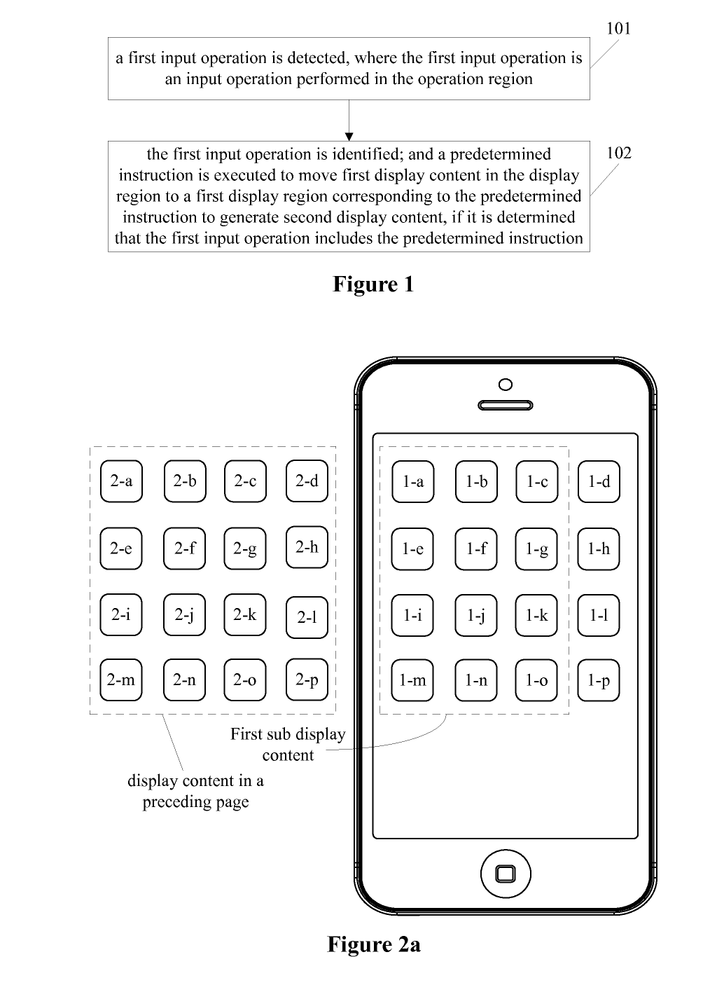

An information processing method is provided according to the embodiment of the disclosure. The information processing method is applied to an electronic device. The electronic device includes a touch display unit including a display region and an operation region. FIG. 1 is a schematic flowchart of the information processing method according to the first embodiment of the disclosure. As shown in FIG. 1, the information processing method includes steps 101 to 102.

In step 101, a first input operation is detected, where the first input operation is an input operation performed in the operation region.

In the embodiment, the touch display unit includes the display region and the operation region. The area of the display region is a whole display area. The operation region may be the display region, that is, the area of the operation region is the same as the area of the display region. Alternatively, the operation region may be smaller than the display region, that is, the area of the operation region is smaller than the area of the display region. If it is detected that the electronic device is held by a right hand or the electronic device is predetermined to be held by the right hand, the operation region may be predetermined to be close to a right border of the display region, and the area of the operation region is smaller than the area of the display region, so that a finger of the right hand performs a gesture operation in the operation region conveniently. If it is detected that the electronic device is held by a left hand or the electronic device is predetermined to be held by the left hand, the operation region may be predetermined to be close to a left border of the display region, and the area of the operation region is smaller than the area of the display region, so that a finger of the left hand performs a gesture operation in the operation region conveniently.

Since the execution subject of the information processing method according to the embodiment of the disclosure is the electronic device, the step of detecting the first input operation includes: detecting, by the electronic device, the first input operation. In practice, the electronic device may be an electronic device having a touch display unit (specifically, a touch display screen), for example, a smartphone, a tablet computer, etc. The first input operation performed in the operation region is not limited to a contact operation directly performed on the touch display unit, and may alternatively be a contactless operation performed a certain distance away from the touch display unit.

In step 102, the first input operation is identified; and a predetermined instruction is executed to move first display content in the display region to a first display region corresponding to the predetermined instruction to generate second display content, if it is determined that the first input operation includes the predetermined instruction, where the first display region is smaller than the display region.

In the embodiment, a mapping relation between trajectory data of an input operation and the predetermined instruction is preset in the electronic device. In the case that the first input operation is detected by the electronic device, a trajectory of the first input operation is detected; and in the case that the trajectory of the first input operation matches the trajectory data in the mapping relation, a predetermined instruction corresponding to the trajectory data is acquired, and the predetermined instruction is executed. In the embodiment, the predetermined instruction is for moving the display content in the display region of the touch display unit.

In the embodiment, the predetermined instruction is associated with a situation whether the electronic device is held by the right hand or the left hand. In the case that the electronic device is held by the left hand, a finger to trigger the operation region of the electronic device is usually the thumb of the left hand, and the user prefers to touch a left portion and a lower portion of the operation region of the touch display unit. In this case, the predetermined instruction indicates controlling the first display content in the display region to be moved to a lower left portion of the display region, that is, the first display region is the lower left portion of the display region, so that the thumb of the left hand of the user can easily perform a touch operation in the first display region. In the case that the electronic device is held by the right hand, a finger to trigger the operation region of the electronic device is usually the thumb of the right hand, and the user prefers to touch a right portion and a lower portion of the operation region of the touch display unit. In this case, the predetermined instruction indicates controlling the first display content in the display region to be moved to a lower right portion of the display region, that is, the first display region is the lower right portion of the display region, so that the thumb of the right hand of the user can easily perform a touch operation in the first display region.

Based on the above, the first input operation associated with the predetermined instruction in the embodiment may be a predetermined input operation associated with the predetermined instruction. Preferably, the first input operation may be a directional operation which is convenient to be performed by single hand. For example, in the case that the electronic device is held by the left hand, the finger to trigger the operation region of the electronic device is usually the thumb of the left hand, and the first input operation may be a gesture operation having a trajectory similar to “ [symbol] ”, i.e., the gesture operation indicates a movement toward a lower left portion. In the case that the electronic device is held by the right hand, the finger to trigger the operation region of the electronic device is usually the thumb of the right hand, and the first input operation may be a gesture operation having a trajectory similar to “ [symbol] ”, i.e., the gesture operation indicates a movement toward a lower right portion. Obviously, the first input operation is not limited to the gesture operations described above.

In the step, the process of executing the predetermined instruction to move first display content in the display region to the first display region corresponding to the predetermined instruction to generate the second display content includes: identifying a first location indicated by the predetermined instruction, where the first location indicates a direction of movement of the first display content; and moving, based on the first location, first sub display content in the first display content to the first display region to generate the second display content, a location where the first sub display content locates in the display region is opposite to the first location.

The first display content is whole display content in the display region, and the first sub display content is a part of the first display content. The second display content is the same as the first sub display content in one embodiment, or the second display content includes the first sub display content in another embodiment.

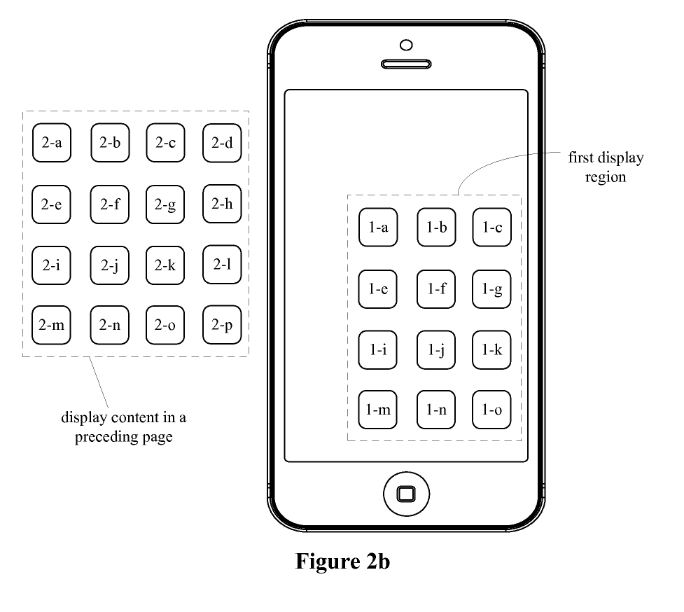

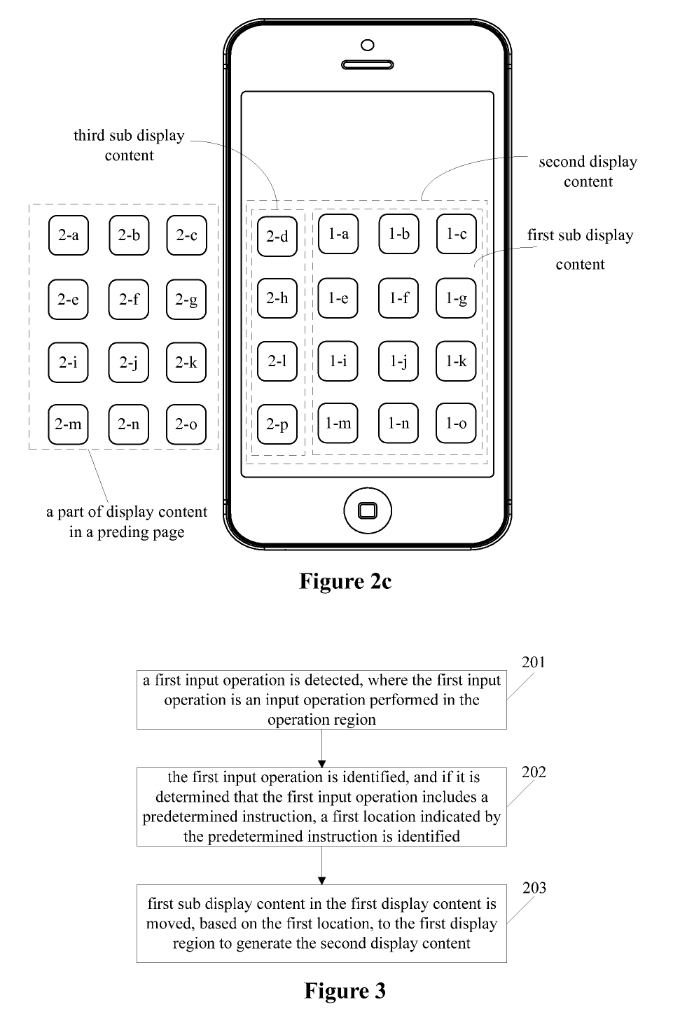

It is illustrated in details with a case that the electronic device is held by the right hand. FIG. 2a to FIG. 2c are schematic diagrams of the display of display content according to an embodiment of the disclosure. As shown in FIG. 2a, an icon 1-a to an icon 1-p are whole display content in the display region. In the case that the predetermined instruction indicates controlling the first display content in the display region to be moved to the lower right portion of the display region, the first location indicated by the predetermined instruction is the lower right portion, that is, the predetermined instruction indicates moving the first sub display content to the lower right portion of the display region. Correspondingly, where the first sub display content locates in the first display content is opposite to the lower right portion, that is, the first sub display content is located at an upper left portion of the first display content. As shown in FIG. 2a, the first sub display content, as denoted with a dotted box, includes 12 icons of the icon 1-a to an icon 1-c, an icon 1-e to an icon 1-g, an icon 1-i to an icon 1-k, and an icon 1-m to an icon 1-o. The number of the first sub display content may be determined according to a predetermined scaling relation between the number of the first sub display content and the size of the display region, or may be predetermined independently, which is not limited to the first sub display content of the 12 icons in the embodiment. As shown in FIG. 2b, the predetermined instruction is executed and the first sub display content is moved, toward the lower right portion, to the first display region, so that the thumb of the right hand easily performs a touch operation in the first display region in the case that the electronic device is held by the right hand of the user. In the embodiment, the second display content is the same as the first sub display content.

In the case that the electronic device is held by the left hand, contrary to the above description, the predetermined instruction indicates controlling the first display content to be moved to the lower left portion of the display region, the first location indicated by the predetermined instruction is the lower left portion, that is, the predetermined instruction indicates moving the first sub display content to the lower left portion of the display region. Correspondingly, where the first sub display content locates in the first display content is opposite to the lower left portion, that is, the first sub display content is located at an upper right portion of the first display content.

The two cases described above may be construed as that a lower part of the electronic device is held by the right hand or the left hand. Cases that an upper part of the electronic device is held by the right hand or the left hand are similar to the above description, which are not described in details herein.

In another embodiment, when moving the first sub display content in the first display content to the first display region based on the first location to generate the second display content, the information processing method further includes: displaying third sub display content of third display content in a second display region, where the second display content includes the third sub display content and the first sub display content, the third display content is associated with the first display content, and the second display region is a display region other than the first display region.

According to an implementation, an association between the third display content and the first display content may be described as follows: in a case of detecting a triggering operation indicating page turning, the display content in the display region is triggered to be switched between the third display content and the first display content; the third sub display content is a part of the third display content, the part being closest to the first display content during a switching between the third display content and the first display content.

As shown in FIG. 2a and FIG. 2c, the icon 1-a to the icon 1-p are whole display content in the display region for a current page, and an icon 2-a to an icon 2-p are whole display content of a page preceding to the current page, that is, the icon 2-a to the icon 2-p may be displayed in the display region of the touch display unit if the touch display unit detects a triggering operation indicating turning to the preceding page. In the case that the predetermined instruction indicates controlling the first display content in the display region to be moved to the lower right portion of the display region, the first location indicated by the predetermined instruction is the lower right portion, that is, the predetermined instruction indicates moving the first sub display content to the lower right portion of the display region. Correspondingly, where the first sub display content locates in the first display content is opposite to the lower right portion, that is, the first sub display content is located at an upper left portion of the first display content. As shown in FIG. 2a, the first sub display content, as denoted with a dotted box, includes 12 icons of the icon 1-a to the icon 1-c, the icon 1-e to the icon 1-g, the icon 1-i to the icon 1-k, and the icon 1-m to the icon 1-o. As shown in FIG. 2b, in the case that the first sub display content is moved to the first display region, at the left of the first display region, there still remains a partial display space available for displaying. In the embodiment, during executing the predetermined instruction to move the first sub display content, toward the lower right portion, to the first display region, sub display content of the preceding page or a next page, which is closest to the partial display space, is added into the partial display space. As shown in FIG. 2c, after a predetermined instruction indicating a movement toward a lower right portion is acquired, the first sub display content is determined, the third sub display content (namely an icon 2-d, an icon 2-h, an icon 2-l and an icon 2-p adjacent to the icon 1-a, the icon 1-e, the icon 1-i and the icon 1-m in the first display content) in the third display content (namely the display content of the preceding page) associated with the first display content is determined, and the second display content is generated through a combination of the third sub display content and the first sub display content. In the embodiment, a display region displaying the second display content is a combination of the first display region and the second display region.

In the above embodiments, where the first display region locates in the display region is identical with the first location indicated by the predetermined instruction, and the first display region is close to at least one border of the display region.

In the case that the first location indicated by the predetermined instruction is the lower right portion, the first display region is located in the lower right portion of the display region, and the first display region is close to a right border and a lower border of the display region. In the case that the first location indicated by the predetermined instruction is an upper right portion, the first display region is located in the upper right portion of the display region, and the first display region is close to a right border and an upper border of the display region. Other cases are similar to the above, which are omitted herein.

In the technical solution in the embodiment of the disclosure, by means of a simple input operation (the first input operation), the display content (the first display content) in the display region, which is far away from an operator, is moved into a region (the first display region) in which the operator can perform operations, thereby significantly reducing an operation blind area of the electronic device held by one hand, simplifying the operation and significantly improving operation experience of the user.

### A Second Embodiment

An information processing method is further provided according to the embodiment of the disclosure. The information processing method is applied to an electronic device. The electronic device includes a touch display unit including a display region and an operation region. FIG. 3 is a schematic flowchart of the information processing method according to the second embodiment of the disclosure. As shown in FIG. 3, the information processing method includes steps 201 to 203.

In step 201, a first input operation is detected, where the first input operation is an input operation performed in the operation region.

In the embodiment, the touch display unit includes the display region and the operation region. The area of the display region is a whole display area. The operation region may be the display region, that is, the area of the operation region is the same as the area of the display region. Alternatively, the operation region may be smaller than the display region, that is, the area of the operation region is smaller than the area of the display region. If it is detected that the electronic device is held by a right hand or the electronic device is predetermined to be held by the right hand, the operation region may be predetermined to be close to a right border of the display region, and the area of the operation region is smaller than the area of the display region, so that a finger of the right hand performs a gesture operation in the operation region conveniently. If it is detected that the electronic device is held by a left hand or the electronic device is predetermined to be held by the left hand, the operation region may be predetermined to be close to a left border of the display region, and the area of the operation region is smaller than the area of the display region, so that a finger of the left hand performs a gesture operation in the operation region conveniently.

Since the execution subject of the information processing method according to the embodiment of the disclosure is the electronic device, the step of detecting the first input operation includes: detecting, by the electronic device, the first input operation. In practice, the electronic device may be an electronic device having a touch display unit (specifically, a touch display screen), for example, a smartphone, a tablet computer, etc. The first input operation performed in the operation region is not limited to a contact operation directly performed on the touch display unit, and may alternatively be a contactless operation performed a certain distance away from the touch display unit.

In step 202, the first input operation is identified, and if it is determined that the first input operation includes a predetermined instruction, a first location indicated by the predetermined instruction is identified, where the first location indicates a direction of movement of first display content.

In the embodiment, a mapping relation between trajectory data of an input operation and the predetermined instruction is preset in the electronic device. In the case that the first input operation is detected by the electronic device, a trajectory of the first input operation is detected; and in the case that the trajectory of the first input operation matches the trajectory data in the mapping relation, a predetermined instruction corresponding to the trajectory data is acquired, and the predetermined instruction is executed. In the embodiment, the predetermined instruction is for moving the display content in the display region of the touch display unit.

In the embodiment, the predetermined instruction is associated with a situation whether the electronic device is held by the right hand or the left hand. In the case that the electronic device is held by the left hand, a finger to trigger the operation region of the electronic device is usually the thumb of the left hand, and the user prefers to touch a left portion and a lower portion of the operation region of the touch display unit. In this case, the predetermined instruction indicates controlling the first display content in the display region to be moved to a lower left portion of the display region, that is, the first location indicates a lower left portion and the first display region is the lower left portion of the display region, so that the thumb of the left hand of the user can easily perform a touch operation in the first display region. In the case that the electronic device is held by the right hand, a finger to trigger the operation region of the electronic device is usually the thumb of the right hand, and the user prefers to touch a right portion and a lower portion of the operation region of the touch display unit. In this case, the predetermined instruction indicates controlling the first display content in the display region to be moved to a lower right portion of the display region, that is, the first location indicates a lower right portion and the first display region is the lower right portion of the display region, so that the thumb of the right hand of the user can easily perform a touch operation in the first display region.

Based on the above, the first input operation associated with the predetermined instruction in the embodiment may be a predetermined input operation associated with the predetermined instruction. Preferably, the first input operation may be a directional operation which is convenient to be performed by single hand. For example, in the case that the electronic device is held by the left hand, the finger to trigger the operation region of the electronic device is usually the thumb of the left hand, and the first input operation may be a gesture operation having a trajectory similar to “ [symbol] ”, i.e., the gesture operation indicates a movement toward a lower left portion. In the case that the electronic device is held by the right hand, the finger to trigger the operation region of the electronic device is usually the thumb of the right hand, and the first input operation may be a gesture operation having a trajectory similar to “ [symbol] ”, i.e., the gesture operation indicates a movement toward a lower right portion. Obviously, the first input operation is not limited to the gesture operations described above.

In step 203, first sub display content in the first display content is moved, based on the first location, to the first display region to generate the second display content, where a location where the first sub display content locates in the display region is opposite to the first location, and the first display region is smaller than the display region.

The first display content is whole display content in the display region, and the first sub display content is a part of the first display content. The second display content is the same as the first sub display content in the embodiment.

It is illustrated in details with a case that the electronic device is held by the right hand. As shown in FIG. 2a, an icon 1-a to an icon 1-p are whole display content in the display region. In the case that the predetermined instruction indicates controlling the first display content in the display region to be moved to the lower right portion of the display region, the first location indicated by the predetermined instruction is the lower right portion, that is, the predetermined instruction indicates moving the first sub display content to the lower right portion of the display region. Correspondingly, where the first sub display content locates in the first display content is opposite to the lower right portion, that is, the first sub display content is located at an upper left portion of the first display content. As shown in FIG. 2a, the first sub display content, as denoted with a dotted box, includes 12 icons of the icon 1-a to an icon 1-c, an icon 1-e to an icon 1-g, an icon 1-i to an icon 1-k, and an icon 1-m to an icon 1-o. The number of the first sub display content may be determined according to a predetermined scaling relation between the number of the first sub display content and the size of the display region, or may be predetermined independently, which is not limited to the first sub display content of the 12 icons in the embodiment. As shown in FIG. 2b, the predetermined instruction is executed and the first sub display content is moved, toward the lower right portion, to the first display region, so that the thumb of the right hand easily performs a touch operation in the first display region in the case that the electronic device is held by the right hand of the user. In the embodiment, the second display content is the same as the first sub display content.

In the case that the electronic device is held by the left hand, contrary to the above description, the predetermined instruction indicates controlling the first display content to be moved to the lower left portion of the display region, the first location indicated by the predetermined instruction is the lower left portion, that is, the predetermined instruction indicates moving the first sub display content to the lower left portion of the display region. Correspondingly, where the first sub display content locates in the first display content is opposite to the lower left portion, that is, the first sub display content is located at an upper right portion of the first display content.

The two cases described above may be construed as that a lower part of the electronic device is held by the right hand or the left hand. Cases that an upper part of the electronic device is held by the right hand or the left hand are similar to the above description, which are not described in details herein.

In the technical solution in the embodiment of the disclosure, by means of a simple input operation (the first input operation), the display content (the first display content) in the display region, which is far away from an operator, is moved into a region (the first display region) in which the operator can perform operations, thereby significantly reducing an operation blind area of the electronic device held by one hand, simplifying the operation and significantly improving operation experience of the user.

### A Third Embodiment

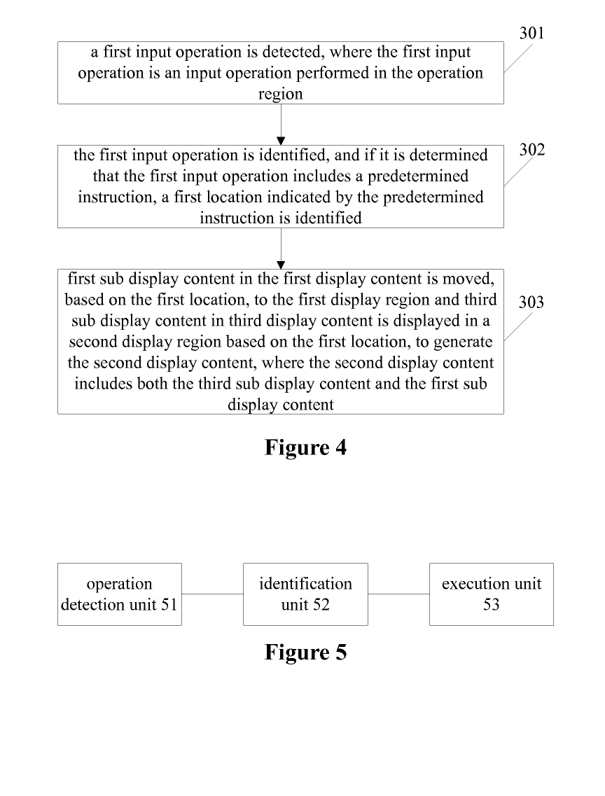

An information processing method is further provided according to the embodiment of the disclosure. The information processing method is applied to an electronic device. The electronic device includes a touch display unit including a display region and an operation region. FIG. 4 is a schematic flowchart of the information processing method according to the third embodiment of the disclosure. As shown in FIG. 4, the information processing method includes steps 301 to 303.

In step 301, a first input operation is detected, where the first input operation is an input operation performed in the operation region.

In the embodiment, the touch display unit includes the display region and the operation region. The area of the display region is a whole display area. The operation region may be the display region, that is, the area of the operation region is the same as the area of the display region. Alternatively, the operation region may be smaller than the display region, that is, the area of the operation region is smaller than the area of the display region. If it is detected that the electronic device is held by a right hand or the electronic device is predetermined to be held by the right hand, the operation region may be predetermined to be close to a right border of the display region, and the area of the operation region is smaller than the area of the display region, so that a finger of the right hand performs a gesture operation in the operation region conveniently. If it is detected that the electronic device is held by a left hand or the electronic device is predetermined to be held by the left hand, the operation region may be predetermined to be close to a left border of the display region, and the area of the operation region is smaller than the area of the display region, so that a finger of the left hand performs a gesture operation in the operation region conveniently.

Since the execution subject of the information processing method according to the embodiment of the disclosure is the electronic device, the step of detecting the first input operation includes: detecting, by the electronic device, the first input operation. In practice, the electronic device may be an electronic device having a touch display unit (specifically, a touch display screen), for example, a smartphone, a tablet computer, etc. The first input operation performed in the operation region is not limited to a contact operation directly performed on the touch display unit, and may alternatively be a contactless operation performed a certain distance away from the touch display unit.

In step 302, the first input operation is identified, and if it is determined that the first input operation includes a predetermined instruction, a first location indicated by the predetermined instruction is identified, where the first location indicates a direction of movement of first display content.

In the embodiment, a mapping relation between trajectory data of an input operation and the predetermined instruction is preset in the electronic device. In the case that the first input operation is detected by the electronic device, a trajectory of the first input operation is detected; and in the case that the trajectory of the first input operation matches the trajectory data in the mapping relation, a predetermined instruction corresponding to the trajectory data is acquired, and the predetermined instruction is executed. In the embodiment, the predetermined instruction is for moving the display content in the display region of the touch display unit.

In the embodiment, the predetermined instruction is associated with a situation whether the electronic device is held by the right hand or the left hand. In the case that the electronic device is held by the left hand, a finger to trigger the operation region of the electronic device is usually the thumb of the left hand, and the user prefers to touch a left portion and a lower portion of the operation region of the touch display unit. In this case, the predetermined instruction indicates controlling the first display content in the display region to be moved to a lower left portion of the display region, that is, the first location indicates a lower left portion and the first display region is the lower left portion of the display region, so that the thumb of the left hand of the user can easily perform a touch operation in the first display region. In the case that the electronic device is held by the right hand, a finger to trigger the operation region of the electronic device is usually the thumb of the right hand, and the user prefers to touch a right portion and a lower portion of the operation region of the touch display unit. In this case, the predetermined instruction indicates controlling the first display content in the display region to be moved to a lower right portion of the display region, that is, the first location indicates a lower right portion and the first display region is the lower right portion of the display region, so that the thumb of the right hand of the user can easily perform a touch operation in the first display region.

Based on the above, the first input operation associated with the predetermined instruction in the embodiment may be a predetermined input operation associated with the predetermined instruction. Preferably, the first input operation may be a directional operation which is convenient to be performed by single hand. For example, in the case that the electronic device is held by the left hand, the finger to trigger the operation region of the electronic device is usually the thumb of the left hand, and the first input operation may be a gesture operation having a trajectory similar to “ [symbol] ”, i.e., the gesture operation indicates a movement toward a lower left portion. In the case that the electronic device is held by the right hand, the finger to trigger the operation region of the electronic device is usually the thumb of the right hand, and the first input operation may be a gesture operation having a trajectory similar to “ [symbol] ”, i.e., the gesture operation indicates a movement toward a lower right portion. Obviously, the first input operation is not limited to the gesture operations described above.

In step 303, first sub display content in the first display content is moved, based on the first location, to the first display region and third sub display content in third display content is displayed in a second display region based on the first location, to generate the second display content, where the second display content includes both the third sub display content and the first sub display content, a location where the first sub display content locates in the display region is opposite to the first location, the first display region is smaller than the display region, the third display content is associated with the first display content, and the second display region is a display region other than the first display region.

As shown in FIG. 2a and FIG. 2c, the icon 1-a to the icon 1-p are whole display content in the display region for a current page, and an icon 2-a to an icon 2-p are whole display content of a page preceding to the current page, that is, the icon 2-a to the icon 2-p may be displayed in the display region of the touch display unit if the touch display unit detects a triggering operation indicating turning to the preceding page. In the case that the predetermined instruction indicates controlling the first display content in the display region to be moved to the lower right portion of the display region, the first location indicated by the predetermined instruction is the lower right portion, that is, the predetermined instruction indicates moving the first sub display content to the lower right portion of the display region. Correspondingly, where the first sub display content locates in the first display content is opposite to the lower right portion, that is, the first sub display content is located at an upper left portion of the first display content. As shown in FIG. 2a, the first sub display content, as denoted with a dotted box, includes 12 icons of the icon 1-a to the icon 1-c, the icon 1-e to the icon 1-g, the icon 1-i to the icon 1-k, and the icon 1-m to the icon 1-o. As shown in FIG. 2b, in the case that the first sub display content is moved to the first display region, at the left of the first display region, there still remains a partial display space available for displaying. In the embodiment, during executing the predetermined instruction to move the first sub display content, toward the lower right portion, to the first display region, sub display content of the preceding page or a next page, which is closest to the partial display space, is added into the partial display space. As shown in FIG. 2c, after a predetermined instruction indicating a movement toward a lower right portion is acquired, the first sub display content is determined, the third sub display content (namely an icon 2-d, an icon 2-h, an icon 2-l and an icon 2-p adjacent to the icon 1-a, the icon 1-e, the icon 1-i and the icon 1-m in the first display content) in the third display content (namely the display content of the preceding page) associated with the first display content is determined, and the second display content is generated through a combination of the third sub display content and the first sub display content. In the embodiment, a display region displaying the second display content is a combination of the first display region and the second display region.

In the case that the first location indicated by the predetermined instruction is the lower right portion, the first display region is located in the lower right portion of the display region, and the first display region is close to a right border and a lower border of the display region. In the case that the first location indicated by the predetermined instruction is an upper right portion, the first display region is located in the upper right portion of the display region, and the first display region is close to a right border and an upper border of the display region. Other cases are similar to the above, which are omitted herein.

In the case that the electronic device is held by the left hand, contrary to the above description, the predetermined instruction indicates controlling the first display content to be moved to the lower left portion of the display region, the first location indicated by the predetermined instruction is the lower left portion, that is, the predetermined instruction indicates moving the first sub display content to the lower left portion of the display region. Correspondingly, where the first sub display content locates in the first display content is opposite to the lower left portion, that is, the first sub display content is located at an upper right portion of the first display content.

The two cases described above may be construed as that a lower part of the electronic device is held by the right hand or the left hand. Cases that an upper part of the electronic device is held by the right hand or the left hand are similar to the above description, which are not described in details herein.

In the technical solution in the embodiment of the disclosure, by means of a simple input operation (the first input operation), the display content (the first display content) in the display region, which is far away from an operator, is moved into a region (the first display region) in which the operator can perform operations, thereby significantly reducing an operation blind area of the electronic device held by one hand, simplifying the operation and significantly improving operation experience of the user.

### A Fourth Embodiment

An electronic device is further provided according to the embodiment of the disclosure. FIG. 5 is a schematic structural diagram of the electronic device according to the embodiment of the disclosure. As shown in FIG. 5, the electronic device includes a touch display unit including a display region and an operation region, and the electronic device further includes: an operation detection unit 51, an identification unit 52 and an execution unit 53.

The operation detection unit 51 is used to detect a first input operation, where the first input operation is an input operation performed in the operation region.

The identification unit 52 is used to identify the first input operation detected by the operation detection unit 51.

The execution unit 53 is used to execute a predetermined instruction to move first display content in the display region to a first display region corresponding to the predetermined instruction to generate second display content, in a case that the identification unit 52 determines that the first input operation includes the predetermined instruction, where the first display region is smaller than the display region.

In the embodiment, where the first display region locates in the display region is identical with a first location indicated by the predetermined instruction, and the first display region is close to at least one border of the display region.

It should be understood by those skilled in the art that the functions of the processing units in the electronic device according to the embodiment of the disclosure may be understood with reference to the above description of the information processing method, and the processing units in the electronic device according to the embodiment of the disclosure may be achieved by using analog circuits for implementing the functions according to the embodiment of the disclosure, or may be achieved by running software, which implements the functions according to the embodiment of the disclosure, on an intelligent terminal.

### A Fifth Embodiment

An electronic device is further provided according to the embodiment of the disclosure. As shown in FIG. 5, the electronic device includes a touch display unit including a display region and an operation region, and the electronic device further includes: an operation detection unit 51, an identification unit 52 and an execution unit 53.

The operation detection unit 51 is used to detect a first input operation, where the first input operation is an input operation performed in the operation region.

The identification unit 52 is used to identify the first input operation detected by the operation detection unit 51.

The execution unit 53 is used to, in a case that the identification unit 52 determines that the first input operation includes a predetermined instruction, identify a first location indicated by the predetermined instruction, where the first location indicates a direction of movement of first display content; and move, based on the first location, first sub display content in the first display content to a first display region to generate second display content, where a location where the first sub display content locates in the display region is opposite to the first location, and the first display region is smaller than the display region.

In the embodiment, where the first display region locates in the display region is identical with a first location indicated by the predetermined instruction, and the first display region is close to at least one border of the display region.

It should be understood by those skilled in the art that the functions of the processing units in the electronic device according to the embodiment of the disclosure may be understood with reference to the above description of the information processing method, and the processing units in the electronic device according to the embodiment of the disclosure may be achieved by using analog circuits for implementing the functions according to the embodiment of the disclosure, or may be achieved by running software, which implements the functions according to the embodiment of the disclosure, on an intelligent terminal.

### A Sixth Embodiment

An electronic device is further provided according to the embodiment of the disclosure. As shown in FIG. 5, the electronic device includes a touch display unit including a display region and an operation region, and the electronic device further includes: an operation detection unit 51, an identification unit 52 and an execution unit 53.

The operation detection unit 51 is used to detect a first input operation, where the first input operation is an input operation performed in the operation region.

The identification unit 52 is used to identify the first input operation detected by the operation detection unit 51.

The execution unit 53 is used to, in a case that the identification unit 52 determines that the first input operation includes a predetermined instruction, identify a first location indicated by the predetermined instruction, the first location indicating a direction of movement of first display content; and move, based on the first location, first sub display content in the first display content to a first display region and display third sub display content in third display content in a second display region based on the first location, to generate second display content, where the second display content includes the third sub display content and the first sub display content, a location where the first sub display content locates in the display region is opposite to the first location, the first display region is smaller than the display region, the third display content is associated with the first display content, and the second display region is a display region other than the first display region.

According to an implementation, an association between the third display content and the first display content may be described as follows: in a case that the operation detection unit 51 detects a triggering operation indicating page turning, the display content in the display region is triggered to be switched between the third display content and the first display content; the third sub display content is a part of the third display content, the part being closest to the first display content during a switching between the third display content and the first display content.

In the embodiment, a location where the first display region locates in the display region is identical with the first location indicated by the predetermined instruction, and the first display region is close to at least one border of the display region.

It should be understood by those skilled in the art that the functions of the processing units in the electronic device according to the embodiment of the disclosure may be understood with reference to the above description of the information processing method, and the processing units in the electronic device according to the embodiment of the disclosure may be achieved by using analog circuits for implementing the functions according to the embodiment of the disclosure, or may be achieved by running software, which implements the functions according to the embodiment of the disclosure, on an intelligent terminal.

In the fourth embodiment to the sixth embodiment of the disclosure, the operation detection unit 51, the identification unit 52 and the execution unit 53 in the electronic device may be achieved by using a central processing unit (CPU), a digital signal processor (DSP) or a field-programmable gate array (FPGA) in the electronic device in practice.

It should be understood by those skilled in the art that the embodiments of the disclosure may be provided as a method, a system, or a computer program product. Therefore, the disclosure may be embodied as hardware, software or a combination of software and hardware. Moreover, the disclosure may be embodied as a computer program product which is run on one or more computer readable storage media (including, but not limited to, a disk storage, an optical storage, and so forth) having computer readable program code stored therein.

The description in the disclosure is made in conjunction with flowchart(s) and block diagram(s) of the method, device (system) or computer program product according to the embodiments of the disclosure. It should be understood that each process in the flowchart and each block in the block diagram and any combination of processes in the flowchart or blocks in the block diagram may be implemented through computer program instructions. The computer instructions may be provided to a processor of a general-purpose computer, a dedicated computer, an embedded processing machine or any other programmable data processing device to generate a machine, so that devices for implementing functions specified in one or more processes of the flowchart or one or more blocks of the block diagram are implemented through executing the instructions by the computer or any other programmable data processing device.

The computer program instructions may be stored in a computer readable storage which may lead the computer or any other programmable data processing device to operate in particular manner in order that a product including an instruction device is generated according to the instructions stored in the computer readable storage, where the instruction device is used to implement the functions specified in one or more processes of the flowchart or in one or more blocks of the block diagram.

The computer program instructions may be loaded to the computer or any other programmable data processing device in order that a series of steps are executed on the computer or any other programmable data processing device to generate processes implemented by the computer, and the steps to implement the functions specified in one or more processes of the flowchart or one or more blocks of the block diagram are provided by the instructions executed on the computer or any other programmable data processing device.

Only a few preferred embodiments of the disclosure are described above and the preferred embodiments are not intended to limit the scope of protection of the disclosure.

1. An information processing method, comprising:
detecting a first input operation, wherein the first input operation is an input operation performed in an operation region of a touch display unit of an electronic device;
identifying the first input operation; and
executing a predetermined instruction to move first display content in a display region of the touch display unit to a first display region corresponding to the predetermined instruction to generate second display content, if it is determined that the first input operation comprises the predetermined instruction, wherein the first display region is smaller than the display region.

2. The method according to claim 1, wherein the process of executing a predetermined instruction to move first display content in a display region of the touch display unit to a first display region corresponding to the predetermined instruction to generate second display content comprises:
identifying a first location indicated by the predetermined instruction, wherein the first location indicates a direction of a movement of the first display content; and
moving, based on the first location, first sub display content in the first display content to the first display region to generate the second display content,
wherein a location where the first sub display content locates in the display region is opposite to the first location.

3. The method according to claim 2, further comprising:
displaying third sub display content in third display content in a second display region, wherein the second display content comprises both the third sub display content and the first sub display content,
wherein the third display content is associated with the first display content, and the second display region is a display region other than the first display region.

4. The method according to claim 3, wherein in a case of detecting a triggering operation indicating page turning, a display content in the display region is triggered to be switched between the third display content and the first display content, and
the third sub display content is a part of the third display content, the part being closest to the first display content during a switching between the third display content and the first display content.

5. The method according to claim 2, wherein a location where the first display region locates in the display region is identical with the first location indicated by the predetermined instruction, and the first display region is close to at least one border of the display region.

6. An electronic device, wherein the electronic device comprises a touch display unit comprising a display region and an operation region, and the electronic device further comprises: an operation detection unit, an identification unit and an execution unit, wherein
the operation detection unit is configured to detect a first input operation, the first input operation being an input operation performed in the operation region;
the identification unit is configured to identify the first input operation detected by the operation detection unit; and
the execution unit is configured to execute a predetermined instruction to move first display content in the display region to a first display region corresponding to the predetermined instruction to generate second display content, in a case that the identification unit determines that the first input operation comprises the predetermined instruction, wherein the first display region is smaller than the display region.

7. The electronic device according to claim 6, wherein the execution unit is configured to identify a first location indicated by the predetermined instruction, the first location indicating a direction of a movement of the first display content; and move, based on the first location, first sub display content in the first display content to the first display region to generate the second display content, wherein a location where the first sub display content locates in the display region is opposite to the first location.

8. The electronic device according to claim 7, wherein the execution unit is further configured to display third sub display content in third display content in a second display region, wherein the second display content comprises both the third sub display content and the first sub display content, the third display content is associated with the first display content, and the second display region is a display region other than the first display region.

9. The electronic device according to claim 8, wherein in a case that the operation detection unit detects a triggering operation indicating page turning, a display content in the display region is triggered to be switched between the third display content and the first display content, and
the third sub display content is a part of the third display content, the part being closest to the first display content during a switching between the third display content and the first display content.

10. The electronic device according to claim 7, wherein a location where the first display region locates in the display region is identical with the first location indicated by the predetermined instruction, and the first display region is close to at least one border of the display region.
